(19) United States
(12) Patent Application Publication
(10) Pub. No.: US 2025/0164032 A1
(43) Pub. Date: May 22, 2025

(54) VALVE FOR A FLUID LINE, DEVICE FOR A FLUID LINE WITH A VALVE, AND USE OF A VALVE

(71) Applicant: Grohe AG, Hemer (DE)

(72) Inventors: Daniel RADERMACHER, Düesseldorf (DE); Kai WERNER, Neuss (DE); Dirk BERGERS, Düsseldorf (DE)

(73) Assignee: Grohe AG, Hemer (DE)

(21) Appl. No.: 18/839,850

(22) PCT Filed: Feb. 2, 2023
(86) PCT No.: PCT/EP2023/052513

§ 371 Date: Aug. 20, 2024

(30) Foreign Application Priority Data
Feb. 25, 2022 (DE) 10 2022 104 577.3

(51) Int. Cl. F16K 37/00; F16K 5/06

(52) U.S. Cl. CPC F16K 37/005; F16K 5/0605

(57) ABSTRACT

A valve (1) for a fluid line (2), comprising at least:
a valve housing (3) having an inlet (4) for a fluid and an outlet (5) for the fluid;
a pressure sensor (6) disposed at least partially inside the valve housing (3); and
at least one valve body (7), which can be moved into an open position (8) to open the valve (1) and into a first closed position (9) and into a second closed position (10) to close the valve (1), wherein the pressure sensor (6) can be used to measure a pressure of the fluid in the inlet (4) in the first closed position (9) and to measure the pressure of the fluid in the outlet (5) in 10 the second closed position (10).

In addition, this invention relates to a device (14) having such a valve (1) and to a usage of such a valve (1).

This invention relates to a valve for a fluid line, a device having such a valve and a usage of a valve. The valve can be used to shut off the fluid line.

Buildings regularly have a large number of fluid lines, for instance in the manner of water pipes, which lead from a fluid source, such as a public water supply network or public gas supply network, to various appliances, such as sanitary faucets, dishwashers, boilers, heaters or washing machines.

Pressure sensors can be installed in these fluid lines, for instance to measure or monitor a supply pressure of the fluid that is used to transport the fluid from the fluid source to the building. This prevents the appliances from being damaged by excessive fluid pressure.

Pressure sensors can also be used to detect leaks in the fluid lines. Methods are known for detecting drip leaks in which a drop in pressure in the fluid lines caused by drip leaks is measured for a longer period of time. When these measuring methods are used, a valve in the fluid lines has to be closed for a longer period of time (e.g., 15 minutes) such that the decrease of pressure in the fluid lines can be measured during this time. To cover various applications, several pressure sensors often have to be disposed in the fluid lines, resulting in high installation effort and high cost.

Therefore, the invention addresses the problem of solving at least a part of the issues described with reference to the prior art and, in particular, of providing a valve for a fluid line whose pressure sensor can be used for various applications. In addition, a device for a fluid line whose pressure sensor can be used for various applications is also disclosed. In addition, the usage of a valve whose pressure sensor can be used for various applications is also disclosed.

These problems are solved by a valve, a device and a usage having the features of the independent claims. Further advantageous embodiments of the invention are specified in the dependent claims. It will be appreciated that the features listed individually in the claims may be combined in any technologically useful manner and define further embodiments of the invention. In addition, the features indicated in the claims are further specified and explained in the description, wherein further preferred embodiments of the invention are illustrated.

A valve for a fluid line, having at least the features listed below, contributes to solving the problem:
a valve housing having an inlet for a fluid and an outlet for the fluid;
a pressure sensor; and
at least one valve body, which can be moved into an open position to open the valve and into a first closed position and into a second closed position to close the valve, wherein the pressure sensor can be used to measure a pressure of the fluid in the inlet in the first closed position and to measure the pressure of the fluid in the outlet in the second closed position.

In particular, the valve can be connected to a fluid line that extends at least partially inside or outside a building and/or from a fluid source to at least one appliance, such as a sanitary faucet, a dishwasher, a boiler, a heater or a washing machine. In particular, the fluid source can be a liquid source, for instance in the manner of a public water supply network, and/or a gas source, for instance in the manner of a public gas supply network. In particular, the fluid line is at least partially made of plastic and/or metal, such as copper, and/or is designed in the manner of a pipe. In particular, the fluid line has a diameter of 10 mm (millimeters) to 60 mm, preferably ½″ [inch] to 2″.

The valve comprises a valve housing having an inlet for a fluid and an outlet for the fluid. The fluid can be a gas or a liquid, in particular water. The valve housing can at least partially be made of plastic and/or metal, such as brass or copper. The inlet and/or outlet can be designed at least partially in the manner of a duct or a drilled hole inside the valve housing. The inlet and/or outlet can:
each have a diameter of 5 mm [millimeters] to 50 mm,
each have a length of 5 mm to 200 mm,
each have an at least partially straight, curved and/or angled shape,
be coaxially aligned with each other and/or
each have a thread for connection to the fluid line.

The inlet and/or outlet can alternatively or cumulatively be soldered, crimped or connected to the fluid line using quick-release fasteners.

The inlet can lead from an inlet opening of the valve housing to at least one valve body of the valve. The outlet can lead from the valve body to an outlet opening of the valve housing.

The valve comprises a (particularly single) pressure sensor. The pressure sensor may be disposed at least partially inside or on the valve housing. In particular, the pressure sensor can be disposed in and/or on a side wall of the valve housing, on an outside of the valve housing and/or cannot be moved relative to the valve housing. Alternatively, the pressure sensor can also be connected to the valve housing and/or the fluid line via a supply line and/or a drilled hole. The valve can be used to measure the pressure of the fluid or, in particular, to convert it into an electrical output variable as a measure of the pressure. The pressure of the fluid can be transferred via a diaphragm to the pressure sensor, for instance. The valve can be connected to a controller, which can be designed in the manner of a microcontroller, for instance.

The valve body of the valve can be at least partially spherical in shape, cylindrical in shape, have a valve body diameter of 10 mm to 150 mm, for instance, be disposed at least partially inside the valve housing and/or be disposed between the inlet and the outlet. The valve can be designed in the manner of a ball valve or cylinder valve. Alternatively, the valve can also have two valve bodies, each of which can, for instance, be designed in the manner of, in particular flat, spools. The valve body can be moved into an open position to open the valve and into a first closed position and a second closed position to close the valve. Alternatively or cumulatively, the valve body can be moved continuously and/or into intermediate positions, e.g., for flow reduction, in which positions the pressure of the fluid in particular, cannot be measured. In particular, the pressure sensor can only be used to measure the pressure of the fluid in the open position, in the first closed position and in the second closed position. In the open position, the fluid can flow in particular from the inlet to the outlet, through the valve, through the valve body and/or through the fluid line. In the first closed position and/or the second closed position, the fluid cannot flow from the inlet into the outlet, through the valve, through the valve body and/or through the fluid line. In the first closed position and/or the second closed position, the inlet and outlet are separated by the valve body in particular. In particular, the valve body can be moved relative to the valve housing, in particular rotated about an axis of rotation. The valve body can be moved, in particular by a user of the valve, manually and/or by an actuator or drive, in particular an electric drive. The drive can be controlled by the controller.

In the first closed position, the pressure sensor can be used to selectively or alternatively measure the pressure of the fluid in the inlet and in the second closed position the pressure of the fluid in the outlet. In the first closed position, the (one) pressure sensor can be used to measure the pressure of the fluid, in particular only in the inlet and/or not in the outlet. In the second closed position, the (same) pressure sensor can be used to measure the pressure of the fluid, in particular only in the outlet and/or not in the inlet. In the first closed position, the pressure sensor can therefore be used to measure the pressure of the fluid (in a flow direction of the fluid from the inlet opening to the outlet opening of the valve housing), in particular downstream of the valve body and/or in the second closed position, the pressure sensor can be used to measure the pressure of the fluid upstream of the valve body. In the first closed position, the pressure sensor can measure in particular the pressure of the fluid at which the fluid is supplied from the fluid source to the building. In the first closed position and/or second closed position, the pressure sensor can be used to measure in particular the pressure of the fluid to detect a leakage. Therefore, a single pressure sensor can be used to measure the pressure of the fluid and/or a leakage in two different areas of the valve and/or in two different areas of the fluid line. The pressure sensor can therefore be used for at least two different applications.

In the open position, the pressure sensor can be used to measure the pressure of the fluid as it flows through the valve. The pressure sensor can therefore be used for a further application or purpose. In the open position, a supply line to the pressure sensor for measuring the operating pressure can be releasable or released by the valve body.

The valve body can be rotated by at least 90° about an axis of rotation between the first closed position and the second closed position. In particular, the valve body can be rotated by at least 180° between the first closed position and the second closed position. For instance, the valve body can be rotated by 90° to 270°, preferably 170° to 190°, particularly preferably (essentially) 180°, about the axis of rotation between the first closed position and the second closed position. The open position of the valve body can be located between the first closed position and the second closed position, in particular exactly between the first closed position and the second closed position. This can mean that the valve body can be rotated from the open position in a first direction of rotation (for instance counterclockwise) at a first angle of rotation about the axis of rotation into the first closed position and/or from the open position in a second direction of rotation (for instance clockwise) (opposite from the first direction of rotation) at a second angle of rotation about the axis of rotation into the second closed position. The first angle of rotation can be equal to the second angle of rotation. For instance, the first angle of rotation and the second angle of rotation can be 45° to 135°, preferably 85° to 95°, particularly preferably (essentially) 90°.

The valve body may comprise a first fluid duct and a second fluid duct, wherein the first fluid duct extends through the valve body and wherein the second fluid duct opens out into the first fluid duct. The first fluid duct can, in particular, extend orthogonally to the axis of rotation, extend completely through the valve body, have a straight course, have a first duct length of, for instance, 5 mm to 50 mm, have a first duct diameter of, for instance, 5 mm to 50 mm and/or intersect the axis of rotation, in particular centrally. The second fluid duct can, in particular, extend orthogonally to the axis of rotation, extend from a circumferential surface of the valve body into the first fluid duct, have a straight course, have a second duct length of, for instance, 2.5 mm to 25 mm, have a second duct diameter of, for instance, 2.5 mm to 50 mm and/or not intersect the axis of rotation. The first duct length can be greater than the second duct length and/or the first duct diameter can be greater than the second duct diameter.

The first fluid duct and the second fluid duct can be orthogonal to each other. In particular, the first fluid duct and the second fluid duct can have a joint T-shaped design.

In the open position of the valve body, the first fluid duct can connect the inlet to the outlet and the second fluid duct can connect the first fluid duct to the pressure sensor. In this way, the liquid can flow from the inlet via the first fluid duct into the outlet when the valve body is in the open position. In addition, when the valve body is in the open position, the fluid can flow to the pressure sensor via the second fluid duct such that the pressure sensor can be used to measure the pressure of the fluid as it flows through the valve.

In the first closed position of the valve body, the first fluid duct and the second fluid duct can connect the inlet to the pressure sensor. As a result, in the first closed position, the fluid can flow from the inlet via the second fluid duct and the first fluid duct to the pressure sensor, such that the pressure sensor can be used to measure the pressure of the fluid in the inlet.

In the second closed position of the valve body, the first fluid duct and the second fluid duct can connect the outlet to the pressure sensor. As a result, in the second closed position, the fluid can flow from the outlet via the second fluid duct and the first fluid duct to the pressure sensor, such that the pressure sensor can be used to measure the pressure of the fluid in the outlet.

According to a further aspect, a device for a fluid line, which has at least one valve according to the invention, is also proposed. The device can, for instance, be designed in the manner of a leakage detector and/or fluid meter. In particular, the valve can be disposed at least partly inside a housing of the device. The fluid meter can in particular be a water meter.

According to a still further aspect, a usage of a valve according to the invention for a leakage detector and/or a water meter is also proposed.

For further details of the device and/or the method, please refer to the description of the valve in its entirety.

The invention and the technical environment are explained in more detail below with reference to the figures. It should be noted that the figures show a particularly preferred embodiment variant of the invention, but the invention is not limited thereto. The same reference numerals are used for the same components in the figures. In an exemplary and schematic manner,

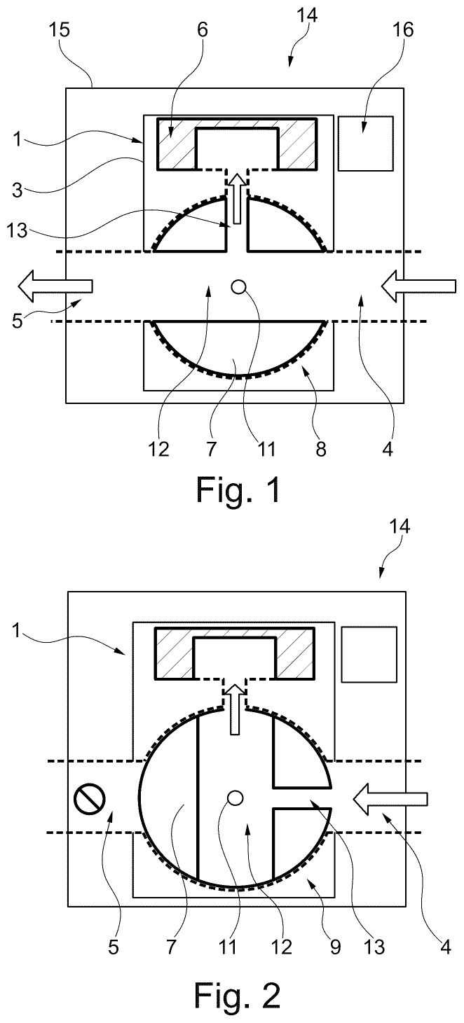

FIG. 1 shows a device having a first embodiment variant of a valve in an open position;

FIG. 2 shows the device having the first embodiment variant of the valve in a first closed position;

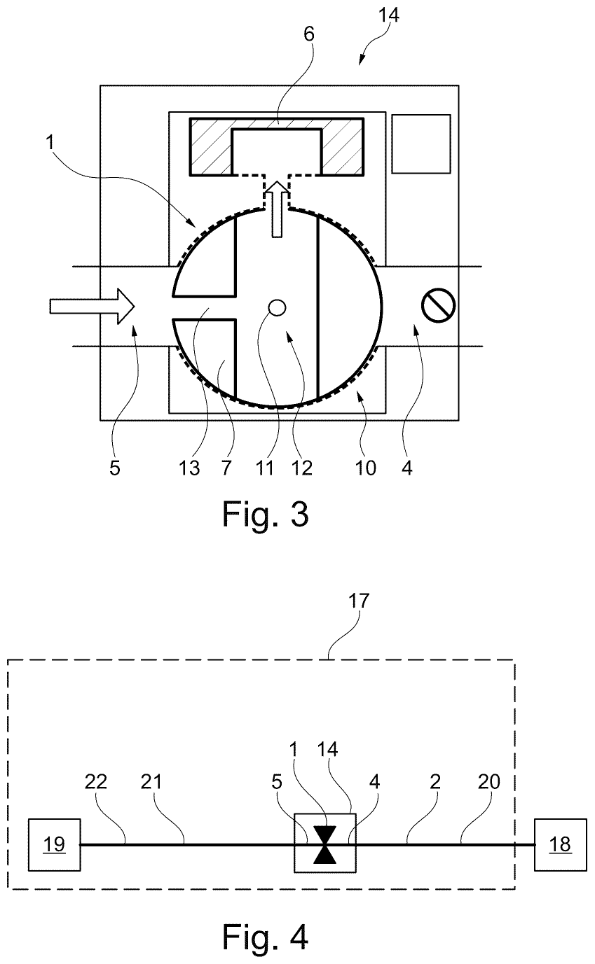

FIG. 3 shows the device having the first embodiment variant of the valve in a second closed position;

FIG. 4 shows a building with the device connected to a fluid line; and

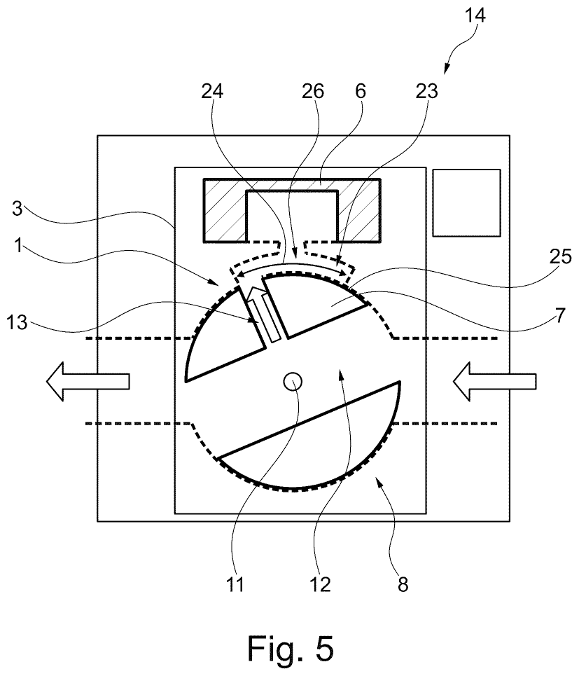

FIG. 5 shows the device having the second embodiment variant of the valve in a partially open position.

FIG. 1 shows a longitudinal section and a partial representation of a device 14 in the manner of a leakage detector. The device 14 comprises a housing 15 in which a first embodiment variant of a valve 1 is disposed. The valve 1 comprises a valve housing 3 having an inlet 4 and an outlet 5 for a fluid. The inlet 4 and the outlet 5 are each formed in the valve housing 3 in the manner of a duct. A valve body 7, which is in an open position 8 in FIG. 1, is disposed between the inlet 4 and the outlet 5. The valve body 7 can be rotated about an axis of rotation 11 relative to the valve housing 3 by means of an actuator (not shown here), which axis of rotation is perpendicular to the plane of the drawing. In the open position 8, a first fluid duct 12 of the valve body 7 connects the inlet 4 to the outlet 5, for the fluid to be able to flow from the inlet 4 through the valve body 7 into the outlet 5. Therefore, in the open position 8 of valve body 7 the valve 1 is open. The valve body 7 also has a second fluid duct 13, which extends orthogonally to the first fluid duct 12 and opens into the first fluid duct 12. The first fluid duct 12 and the second fluid duct 13 are therefore T-shaped. In the open position 8 of the valve body 7, the second fluid duct 13 connects the first fluid duct 12 to a pressure sensor 6 of the valve 1, such that the pressure sensor 6 can be used to measure a pressure of the fluid as it flows through the valve 1. The pressure sensor 6 is disposed in the valve housing 3 and connected to a controller 16 of the device 14.

FIG. 2 shows the device 14 having the first embodiment variant of the valve 1 after the valve body 7 has been rotated clockwise by 90° around the axis of rotation 11 into a first closed position 9 compared to the open position 8 shown in FIG. 1. In the first closed position 9, a connection between the inlet 4 and the outlet 5 is interrupted, i.e., the valve 1 is closed. In the first closed position 9, the pressure sensor 6 is connected to the inlet 4 via the first fluid duct 12 and the second fluid duct 13 of the valve body 7, such that the pressure sensor 6 can be used to measure a pressure of the fluid in the inlet 4.

FIG. 3 shows the device 14 having the first embodiment variant of the valve 1 after the valve body 7 has been rotated 180° about the axis of rotation 11 into a second closed position 10 compared to the first closed position 9 shown in FIG. 2. In the second closed position 10, the connection between the inlet 4 and the outlet 5 is interrupted, i.e., the valve 1 is closed. In the second closed position 10, the pressure sensor 6 is connected to the outlet 5 via the first fluid duct 12 and the second fluid duct 13 of the valve body 7, such that the pressure sensor 6 can be used to measure the pressure of the fluid in the outlet 5.

FIG. 4 schematically shows a building 17 having the device 14. The device 14 is disposed in a fluid line 2 or connected to the fluid line 2, such that the inlet 4 and the outlet 5 of the valve 1 are connected to the fluid line 2. The fluid can be routed from a fluid source 18 to an appliance 19 by means of the fluid line 2. The device 14 has the valve 1, which can used to be close or shut off the fluid line 2. If the valve body 7 of the valve 1 is in the open position 8 shown in FIG. 1, the pressure sensor 6 of the valve 1 can be used to measure the pressure of the fluid flowing through the valve 1. If the valve body 7 of the valve 1 is in the first closed position 9 shown in FIG. 2, the pressure sensor 6 of the valve 1 can be used to measure the pressure of the fluid in the inlet 4 of the valve 1 or in a first line section 20 of the fluid line 2 located upstream of the valve 1. If the valve body 7 of the valve 1 is in the second closed position 10 shown in FIG. 3, the pressure sensor 6 of the valve 1 can be used to measure the pressure of the fluid in the outlet 5 of the valve 1 or in a second line section 21 located downstream of the valve 1. In the second closed position 10 of the valve body 7, a pressure chamber 22 can also be formed in the fluid line 2. The pressure chamber 22 extends from the valve 1 to the appliance 19. The pressure sensor 6 of the valve 1 can be used to determine the pressure of the fluid and thus a pressure drop in the pressure chamber 22 when the valve body 7 (as shown in FIG. 3) is in the second closed position 10.

FIG. 5 shows the device 14 having a second embodiment variant of the valve 1. The second embodiment variant of the valve 1 differs from the first embodiment of the valve 1 only in that the valve housing 3 has a third fluid duct 23. The third fluid duct 23 can, for instance, be designed in the manner of a slot, distribution slot, gap or groove and/or be disposed between the valve body 7 and the pressure sensor 6. The third fluid duct 23 extends at an angle 24 around the axis of rotation 11 of the valve body 7, around the valve body 7 and/or around a circumferential surface 25 of the valve body 7, such that the second fluid duct 13 opens out into the third fluid duct 23 when the valve body 7 is in a partially open position 8. If the valve body 7 (as shown in FIG. 1) is completely in the open position 8, the second fluid duct 13 of the valve body 7 opens in particular out into a center 26 or into a middle of the third fluid duct 23. Alternatively or cumulatively, the third fluid duct 23 permits the first fluid duct 12 and the second fluid duct 13 to be not orthogonal to each other. The angle 24 can be between 45° and 135°, for example. In the partially open position 8 of the valve body 7, the second fluid duct 13 connects the first fluid duct 12 to the pressure sensor 6 of the valve 1 via the third fluid duct 23, such that the pressure sensor 6 can be used to measure the pressure of the fluid as it flows through the valve 1. In all other respects, the second embodiment variant of the valve 1 is configured identically to the first embodiment variant of the valve 1.

Alternatively or cumulatively, the third fluid duct 23 can also be formed in the circumferential surface 25 of the valve body 7. The third fluid duct 23 can be designed as described above and/or as shown in FIG. 5. The third fluid duct 23 can have a triangular cross-section. In particular, the second fluid duct 13 of the valve body 7 opens out into the center 26 or into the middle of the third fluid duct 23.

The third fluid duct 23 permits the flushing of a duct between the second fluid duct 13 and the pressure sensor 6, in particular as a secondary function, as stagnant water areas are only permissible to a very limited extent, particularly where drinking water is concerned, due to possible bacteria formation, etc.

In particular, this invention permits the pressure sensor 6 to be used for various applications.

### LIST OF REFERENCE NUMERALS AND TERMS

1 valve
2 fluid line
3 valve housing
4 inlet
5 outlet
6 pressure sensor
7 valve body
8 open position
9 first closed position
10 second closed position
11 axis of rotation
12 first fluid duct
13 second fluid duct
14 device
15 body
16 controller
17 building
18 fluid source
19 appliance(s)
20 first line section
21 second line section
22 pressure chamber
23 third fluid duct
24 angle
25 circumferential surface
26 center

1. A valve (1) for a fluid line (2), comprising at least:
a valve housing (3) having an inlet (4) for a fluid and an outlet (5) for the fluid;
a pressure sensor (6); and
at least one valve body (7), which can be moved into an open position (8) to open the valve (1) and into a first closed position (9) and into a second closed position (10) to close the valve (1), wherein the pressure sensor (6) can be used to measure a pressure of the fluid in the inlet (4) in the first closed position (9) and to measure the pressure of the fluid in the outlet (5) in the second closed position (10).

2. The valve (1) according to claim 1, wherein in the open position the pressure sensor (6) can be used to measure (8) the pressure of the fluid as it flows through the valve (1).

3. The valve (1) according to claim 1, wherein the valve body (7) can be rotated by at least 90° about an axis of rotation (11) between the first closed position (9) and the second closed position (10).

4. The valve (1) according to claim 1, wherein the valve body (7) comprises a first fluid duct (12) and a second fluid duct (13), wherein the first fluid duct (12) extends through the valve body (7) and wherein the second fluid duct (13) opens out into the first fluid duct (12).

5. The valve (1) according to claim 4, wherein the first fluid duct (12) and the second fluid duct (13) are orthogonal to each other.

6. The valve (1) according to claim 4, wherein in the open position (8) of the valve body (7) the first fluid duct (12) connects the inlet (4) to the outlet (5) and the second fluid duct (13) connects the first fluid duct (12) to the pressure sensor (6).

7. The valve (1) according to claim 4, wherein the first fluid duct (12) and the second fluid duct (13) connect the inlet (4) to the pressure sensor (6) in the first closed position (9) of the valve body (7).

8. The valve (1) according to claim 4, wherein the first fluid duct (12) and the second fluid duct (13) connect the outlet (5) to the pressure sensor (6) in the second closed position (10) of the valve body (7).

9. A device (14) for a fluid line (2), comprising a the valve (1) according to claim 1.

10. Usage of a valve (1) according to claim 1 for a leakage detector or a fluid meter.
